(19) United States
(12) Patent Application Publication
(10) Pub. No.: US 2006/0192651 A1
(43) Pub. Date: Aug. 31, 2006

(54) Data transmit system and transmit methods by using n-dimensional information

(76) Inventor: You-Young Lee, Yong-In City (KR)

Correspondence Address: PERKINS COIE LLP, P.O. BOX 2168, MENLO PARK, CA, 94026, US

(21) Appl. No.: 10/550,311

(22) PCT Filed: Mar. 22, 2004
(86) PCT No.: PCT/KR04/00621

§ 371 Date: Sep. 22, 2005

(30) Foreign Application Priority Data
Mar. 22, 2003 (KR) 10-2003-0018051

(51) Int. Cl. G05B 19/00

(52) U.S. Cl. 340/5.6; 340/5.52; 380/44; 713/186

(57) ABSTRACT

The present invention relates to a system and method of transmitting information using a one-time encryption algorithm based on N-dimension information, as in transmitting data between a client system (10) and a server system (20), and between a client system (10) and a client system (10). Using T_f (100) information, which is the highest rank of File_f, which is N-dimension information, M_f.n (200) which is the lowest rank information related to the above T_f information, File_f information comprised of B_f (300), which is the lowest rank information related to the above M_f.n information, and N-dimension information, which is the collection of the above File_f information, the effect of adapting a native encryption algorithm is accepted whenever transmitting important information. This is accomplished by adapting the encryption operation process based on N-dimension information regarding information which is selected to be sent/received form a client system (10) or a server sytem (20).

### TECHNICAL FIELD

The present invention relates to a data transmission system over a wired/wireless communication network, more particularly, to a data transmission system and transmitting methods by using N-dimensional information to safely transmit/receive the information a user wants to transmit.

### BACKGROUND ART

When a user transmits/receives data over a wired/wireless communication network, there is a chance that the user's ID/Password and (personal or important) information exchanged with others might by leaked by a third party (i.e. a cracker) using network listening and IP spoofing and so forth. What is worse is that the third part acquires encrypted user authentication information and retransmit the encrypted user authentication information to an authentication server to be authenticated, and then does wrongful things like money transaction or stock trading, spoofing as the real user. Because the user authentication information that is transmitted after the encryption process is given to the third party and decrypted by the authentication server using the same method to be retransmitted, the purpose of encryption is lost. Therefore, there was a growing need to develop OTP (One Time Password) technologies. In general, there are two types of OTP technologies: one is the OTP technology using a time synchronous mechanism and the other is the OTP technology using a challenge—response mechanism.

In case of the OTP technology with an application of the time synchronous mechanism, time is used as an encryption variable for creating a one time password. To this end, an international time synchronous system had to be constructed. Even though Greenwich time could be used, in reality it is not easy to apply such system because of time difference in the intersystem and of different application times in different nations. The time difference actually causes another deadly problem to the OTP technology using the time synchronous mechanism. In other words, since the one time password is created every minute and the user is authenticated by the authentication server through the one time password, the third party who acquired the user authentication information being transmitted can retransmit the information to another authentication server within one minute and is authenticated.

Meanwhile, in case of the OTP technology with an application of the challenge—response mechanism the user, in order to create a one time password, need to purchase a separate operating system for operation processing of the one time password. Either the user has to carry around the operating system all the time or memorize a next one time password. In addition, there is always a danger of duplication of user certificate by the third party even when a PKI—based certificate, which is the most widely used data transmission method at present, is used for data transmission. If the third party copied the authentication related information only while leaving a portable storage untouched, there is no way for the user to realize his certificate has been copied by the cracker. Naturally the user does not report the certificate loss and apply for re-issuance of the certificate, leaving more room for the danger of dishonest deeds of the third party.

Finally, there is an encryption and user authentication system using biometric information of the user. In this case, however, the user has to purchase a costly biometric terminal to use the user's own biometric information so the system is not much favored by many users. Moreover, when the biometric information of the user is leaked, every security systems based on the biometric information loses its function.

### DISCLOSURE OF INVENTION

It is, therefore, an object of the present invention to provide a data transmission system and transmitting methods by using N-dimensional information to enable data exchange and user authentication at a high level of security, by applying an N-dimensional information—based operation processing to data to be transmitted/received between clients and between the client and the server over a wired/wireless communication network and thus, creating data with an application of one time encryption algorithm.

### BRIEF DESCRIPTION OF DRAWINGS

The above objects, features and advantages of the present invention will become more apparent from the following detailed description when taken in conjunction with the accompanying drawings, in which:

FIG. 1 illustrates a basic information unit structure diagram of N-dimensional information according to the present invention;

FIG. 2 illustrates a set of basic information unit structure diagram of N-dimensional information according to the present invention;

FIG. 3 is a block diagram showing a Client/Server System according to the present invention;

FIG. 4 is a flow chart describing a client authentication procedure by a Server System according to the present invention;

FIG. 5 is a flow chart describing a procedure for transmitting authentication information by a Client System according to the present invention; and

FIG. 6 is a flow chart describing a data transmitting procedure to which data encryption algorithm of the present invention is applied.

### BEST MODE FOR CARRYING OUT THE INVENTION

A preferred embodiment of the present invention will now be described with reference to the accompanying drawings.

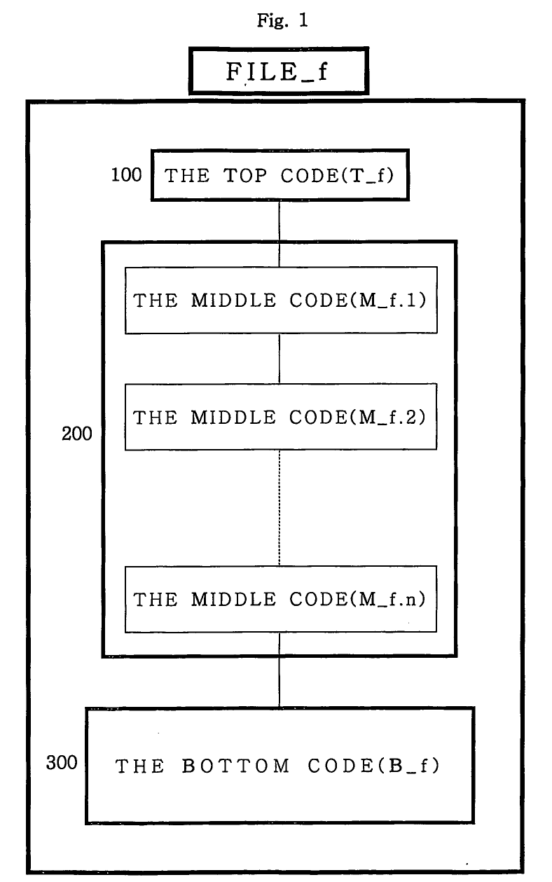

FIG. 1 illustrates a basic information unit structure diagram of N-dimensional information according to the present invention.

The basic information unit for N-dimensional information, FILE_f, includes THE TOP CODE_f 100, THE MIDDLE CODE_f.n 200, and THE BOTTOM CODE_f 300 (wherein ‘f’ indicates a FILE number and ‘n’ indicates a positive integer).

For convenience of explanation, the THE TOP CODE_f 100 is denoted as ‘T_f’, THE MIDDLE CODE_f.n 200 as ‘M_f.n, and THE BOTTOM CODE_f 300 as ‘B_f’.

For example, in case of FILE_{—}0, THE TOP CODE_f 100 can be denoted as T_{—}0, THE MIDDLE CODE_f.n 200 as M_{—}0.n, and THE BOTTOM CODE_f 300 as B_{—}0.

The T_f information is top layer information, constructing the basic information unit of the N-dimensional information, i.e. FILE_f. The T_f information includes combined information of codes that are created when inputting keys on a keyboard or keypad for use in a computer, portable communication equipment or equipment with an entries/employee punching controller; and biometric information obtained by means of a biometric terminal. To structure the T_f information, a user may use biometric information obtained through the biometric terminal or if the user does not own the biometric terminal, the user may combine key codes on the keyboard or keypad.

The M_f.n information is middle layer information between the top layer information (T_f information) and the bottom layer information (B_f information). The M_f.n information functions as variable information to apply N-dimensional information—based encryption algorithm to the data to be transmitted/received between clients and between the client and the server over a wired/wireless communication network. The M_f.n includes ‘n’ middle layer information from M_f.1 to M_f.n (wherein ‘n’ is a positive integer). The M_f.1 is bottom layer information related to the T_f, and M_f.n−1 is upper layer information of the M_f.n information (wherein, n≧2).

The B_f information is bottom layer information out of the N-dimensional basic information unit, FILE_f information. Also, the B_f information is the lower layer information related to the M_f.n information. For example, a picture the user painted, the user's autograph, every kind of biometric information about the user, and combined information using random key values on the keyboard/keypad can be used as the B_f information.

To be short, the N-dimensional basic information unit, namely the FILE_f information, includes the T_f information (the top layer information), the M_f.n information (the lower layer information related to the T_f information), and the B_f information (the lower layer information related to the M_f.n information).

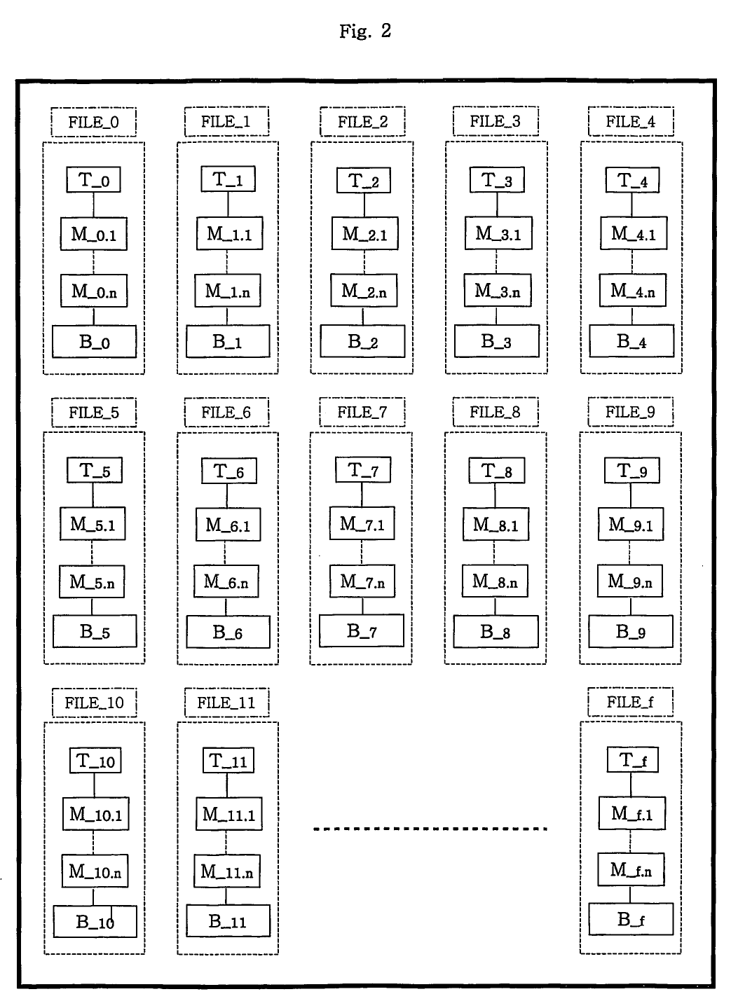

FIG. 2 illustrates a set of the N-dimensional information, including N basic information units. The N-dimensional information is stored in a portable storage device or storage in general.

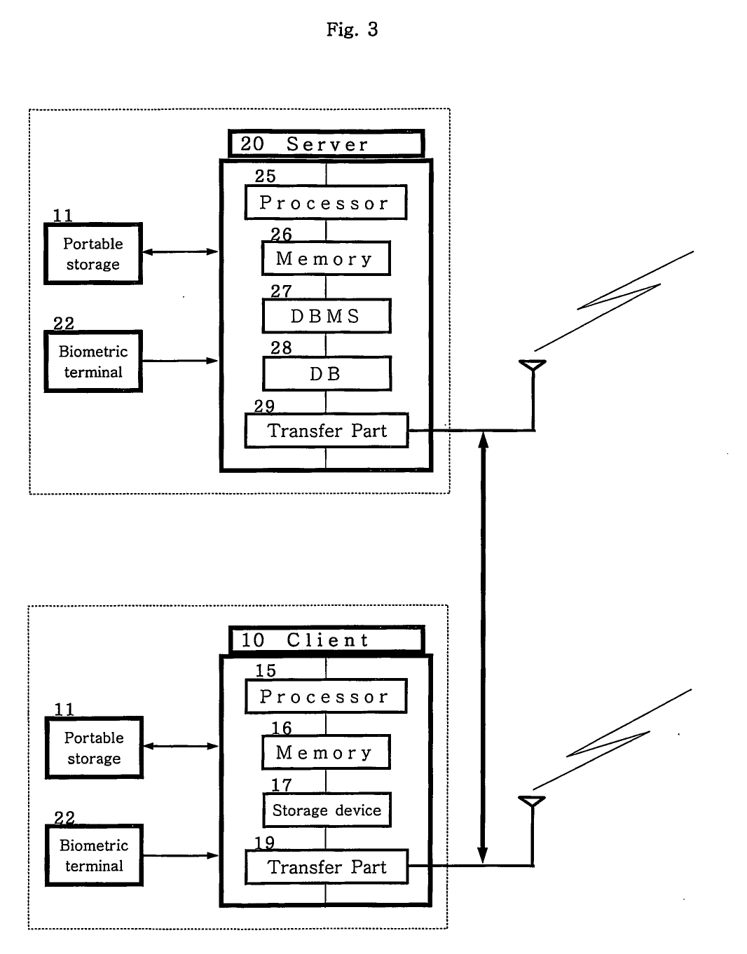

FIG. 3 illustrates a Client System 10 and a Server System 20, in accordance with the present invention.

As for the Client System 10 there are network system character based terminals having built-in wired/wireless communication functions, such as personal computers, cell phones, PDAs, and smart phones, and local system character based terminals, such as entries/employee punching control terminals. The Server System 20 indicates an authentication server for an authentication center and for a financial institution including bank and Securities Company.

As shown in FIG. 3, the Client System 10 includes a processor 15 for controlling generic functions of the Client System 10, a memory 16 connected to the processor 15 and storing activated information, a storage device 17 connected to the processor 15 and storing N-dimensional information, and a transfer part 19 connected to the processor 15 and transmitting/receiving information. The Server System 20 includes a processor 25 for controlling generic functions of the Server System, a memory 26 connected to the processor 25 and storing activated information, DBMS 27 connected to the processor 25 and managing database, DB 28 connected to the processor 25 and storing N-dimensional information, and a transfer part 29 connected to the processor 25 and transmitting/receiving information.

Both the Client System 10 and the Server System 20 are connected to a portable storage 11 or biometric terminal 22.

Functions of each of the processors 15 and 25 for the Client System 10 and the Server System 20, respectively, include: transmitting/receiving the N-dimensional T_f 100 combined information; receiving the N-dimensional T_f 100 combined information from the keyboard or keypad included in each System 10 or 20; searching lower layer information M_f.1 200 combined information related to the transmitted/received or inputted N-dimensional T_f 100 combined information; searching lower layer information M_f.n 200 combined information (n≧2) related to the M_f.1 200 combined information; searching lower layer information B_f 200 combined information related to the M_f.n 200 combined information; searching lower layer information B_f 300 combined information related to the transmitted/received or inputted T_f 100 combined information; applying to the searched B_f 300 combined information an encryption processing using the searched M_f.n combined information as a variable; applying to data to be transmitted an encryption processing using the searched M_f.n combined information as a variable; and applying the received information a decryption processing using the searched M_f.n combined information as a variable. On the basis of the above-described procedure, each procedure 15 or 25 includes additional functions of searching upper layer information M_f.n 200 information related to the B_f 100 information that can be used as a variable for encryption and decryption of the upper layer information T_f 100 information having been searched by using the transmitted/received or inputted M_f.n 200 information; and searching upper layer information T_f 100 information related to the M_f.n 200 information.

The encryption and decryption processing is characterized of applying to the data to be transmitted an operation processing including octet substitute operation, bit substitute operation and a particular function using the N-dimensional T_f 100 combined information or M_f.n 200 combined information as a variable.

In the Client System 10, the memory 16 stores data that is used to search the N-dimensional information and operation data using the N-dimensional information. The storage device 17 is a fixed storage device like a hard disk and stores the N-dimensional information. The transfer part 19 transmits/receives the N-dimensional T_f information and other information on which the N-dimensional information—based operation processing is performed.

In the Server System 20, the memory 26 stores data that is used to search the N-dimensional information and operation data using the N-dimensional information. The DBMS 27 manages the DB where the N-dimensional information is stored. The DB 28 stores the N-dimensional information. The transfer part 29 transmits the N-dimensional T_f 100 information or M_f.n 200 information and receives other information on which the N-dimensional information—based operation processing is performed.

As for the portable storage 11, USB port connecting memory with a built-in memory, memory stick, and other types of portable storage including IC Chip can be employed. Similar to the DB, the portable storage 11 stores the N-dimensional information.

The biometric terminal 22 is capable of extracting user's biometric information including finger prints, iris, vein, face, voice and so on. Particularly, the biometric terminal 22 extracts biometric information of the user who registered the N-dimensional T_f information as the biometric information.

The Client System 10 is also characterized of: transmitting combined information composed of N-dimensional T_f combined information; receiving combined information structure of T_f combined information; searching lower layer information M_f.n information related to the received T_f information; searching lower layer information B_f information related to the searched M_f.n information; searching lower layer information B_f information related to the T_f information that is inputted by the user through the keyboard or keypad or biometric terminal of the Client System 10; applying to data to be transmitted an encryption processing including octet substitute operation, bit substitute operation and particular function using the searched M_f.n information as a variable and transmitting the data; and applying to the received data a decryption processing including octet substitute operation, bit substitute operation and particular function using the searched M_f.n information as a variable.

The Server System 20 is characterized of: transmitting combined information composed of N-dimensional T_f combined information; receiving combined information structure of T_f combined information; searching lower layer information M_f.n information related to the received T_f information; searching the authentication information the client registered; applying to the searched authentication information an encryption processing including octet substitute operation, bit substitute operation and particular function using the searched M_f.n information as a variable; receiving the authentication information from the client; comparing the authentication information from the client to the encrypted data and if coincident, performing the authentication processing; and applying to the received authentication information from the client a decryption processing including octet substitute operation, bit substitute operation and particular function using the searched M_f.n information as a variable, comparing the authentication information the client registered to the decrypted information and if coincident, performing the authentication processing.

Other objectives, features and advantages of the present invention will be apparent through further discussion on other embodiments illustrated in the drawings.

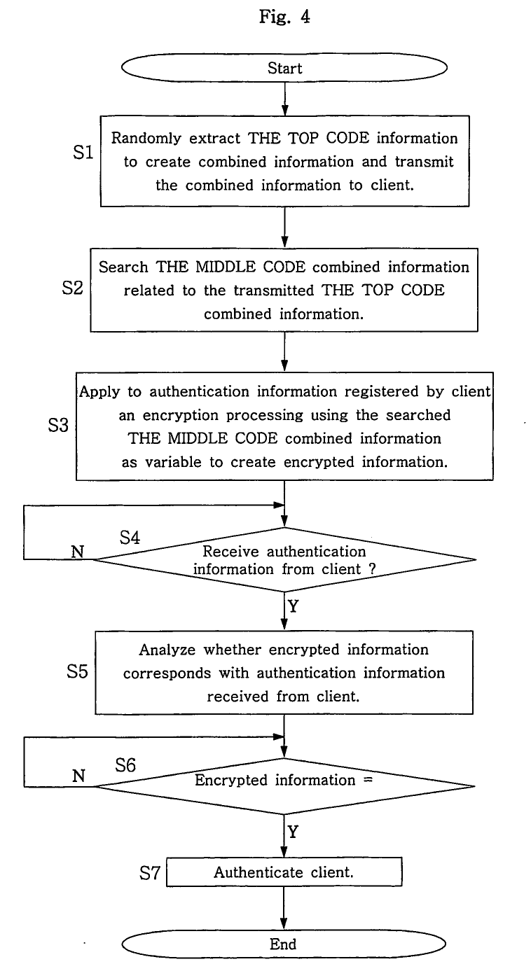

A preferred embodiment of the data transmission system and transmitting method using the N-dimensional information in the Client System 10 and Server System 20 will now be explained with the reference with FIGS. 4 to 6.

For authentication between the Client System 10 and the Server System 20, the client creates N-dimensional information at a financial institute or an authentication center, and registers and stores the N-dimensional information in the storage device 17 of the Client System 10 and in the DB 28 and portable storage 11 of the Server System 20, respectively.

FIG. 4 is a flow chart describing one embodiment of data transmitting procedure using the N-dimensional information, which takes place in the Server System 20 and in the Client System 10 according to the present invention, the procedure including the steps of: (a) randomly extracting N-dimensional T_f 100 information to create combined information and transmitting the combined information to the Client System 20 that requests authentication (S1); (b) searching lower layer information M_f.n 200 combined information related to the transmitted T_f 100 combined information (S2); (c) applying to the authentication information registered by the client an encryption processing using the searched M_f.n 200 combined information as a variable to create encrypted information (S3); (d) receiving the authentication information from the client (S4); (e) analyzing whether the encrypted information corresponds with the authentication information received from the client (S5); and (f) if the encrypted information corresponds with the authentication information from the client (S6), authenticating the client and processing requirement of the client (S7).

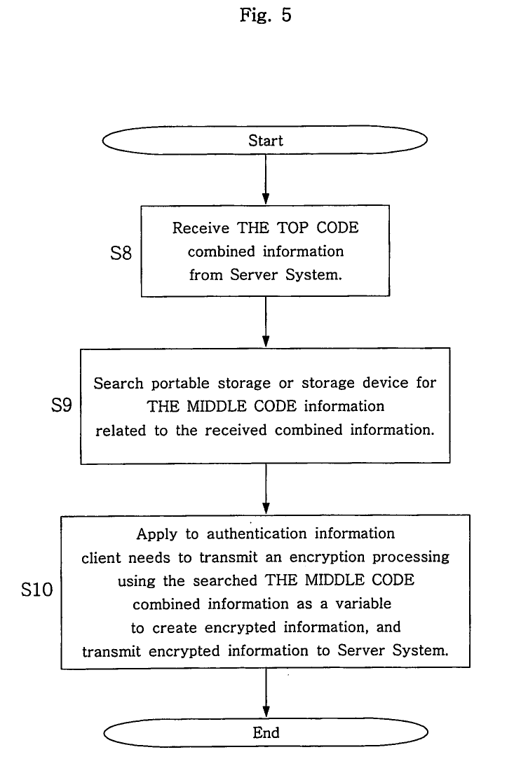

FIG. 5 is a flow chart describing another embodiment of data transmission procedure using the N-dimensional information according to the present invention, in which the Client System 10 transmits authentication information to the Server System 20, the procedure including the steps of: (g) receiving the N-dimensional T_f 100 combined information from the Server System 20 (S8); (h) searching the portable storage 11 or the storage device 17 for the lower layer information M_f.n 200 combined information related to the received T_f 100 combined information; and (i) applying to the authentication information the client needs to transmit an encryption processing using the searched M_f.n 200 combined information as a variable to create the encrypted information, and transmitting the encrypted information being created to the Server System 20 (S10).

If the encrypted information needs to be transmitted between different Client Systems 10, before transmitting the encrypted information the client creates N-dimensional information according to the present invention, shares the T_f 100 information and the M_f.n 200 information and stores the information in the storage device 17 and portable storage 11 of the Client System 10, respectively.

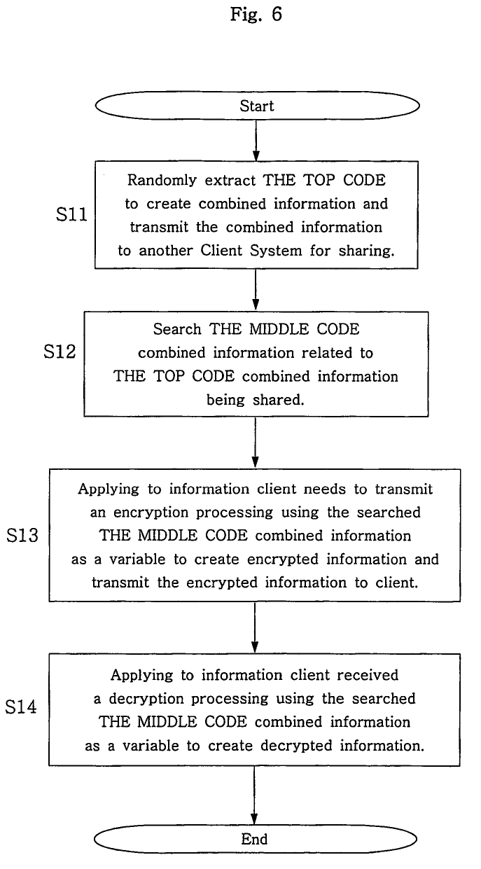

FIG. 6 is a flow chart describing one embodiment of data transmitting procedure using the N-dimensional information according to the present invention to transmit/receive encrypted information, in which the encrypted information is transmitted between different Client Systems 10, the procedure including the steps of: (j) randomly extracting N-dimensional T_f 100 information to create combined information, and transmitting the combined information to another Client System for information exchange and sharing (S11); (k) searching lower layer information M_f.n 200 combined information related to the T_f 100 combined information being shared (S12); (l) applying to the information the client needs to transmit an encryption processing using the searched M_f.n 200 combined information as a variable to create encrypted information, and transmitting the encrypted information to the client (S13); and (m) applying to the information the client received a decryption processing using the searched M_f.n 200 combined information as a variable to create decrypted information.

While the invention has been shown and described with reference to certain preferred embodiments thereof, it will be understood by those skilled in the art that various changes in form and details may be made therein without departing from the spirit and scope of the invention as defined by the appended claims.

### INDUSTRIAL APPLICABILITY

As for the authentication process between the Client System 10 and the Server System 20 and for the data transmission between Client Systems 10, the N-dimensional T_f 100 information, M_f.n 200 information and B_f 300 information are used and the encryption processing, which uses the M_f.n 200 combined information related to the transmitted/received T_f 100 combined information as a variable, is applied to the information the Client System 10 or the Server System 20 needs to transmits. Therefore, the present invention provides a unique encryption algorithm.

What is claimed is:

1. A data transmission system using N-dimensional information, wherein the N-dimensional information comprises:
basic information unit File_f information comprised of at least two layer information combinations among a top layer information T_f information, a middle layer information M_f.n information related to the T_f information, and a bottom layer information B_f information related to the T_f information or the M_f.n information;
a data structure of the N-dimensional information comprised of the File_f information; and
a storage for storing the data structure of the N-dimensional information.

2. The data transmission system according to claim 1, wherein the top layer information T_f information is composed of information that is created by a keyboard/keypad or biometric terminals comprised in a Client system and Server System, respectively, and accessed through code information generated by the keyboard/keypad input or through biometric information of the client acquired from the biometric terminals;
wherein the middle layer information M_f.n information is composed of n-dimensionally related middle layer information from M_f.1 information to M_f.n information, the M_f.1 information being lower layer information related to the top layer information T_f information and the M_f.n information being upper layer information of the B_f information and M_f.n−1 information being upper layer information of the M_f.n information, and used as a variable for an encryption processing based on the N-dimensional information; and
wherein the B_f information is composed of authentication information the client registers to the DB of the Server System.

3. A data transmitting methods using N-dimensional information, wherein an authentication processing of Server System comprises the steps of:
randomly extracting N-dimensional T_f information to create combined information and transmitting the combined information to Client System;
searching lower layer information M_f.n combined information related to the transmitted T_f combined information;
applying to the authentication information registered by a client an encryption processing using the searched M_f.n combined information as a variable to create encrypted information; and
if the encrypted information corresponds with the authentication information from the client, authenticating the client.

4. A data transmitting methods using N-dimensional information, wherein an authentication processing of Client System comprises the steps of:
receiving N-dimensional T_f combined information from Server System;
searching a portable storage or storage device for lower layer information M_f.n combined information related to the received T_f combined information; and
applying to authentication information a client needs to transmit an encryption processing using the searched M_f.n combined information as a variable to create the encrypted information, and transmitting the encrypted information being created to Server System.

5. A data transmitting methods using N-dimensional information, wherein a method for transmitting/receiving encrypted information between Client Systems that share N-dimensional T_f information and M_f.n information comprises the steps of:
randomly extracting N-dimensional T_f information to create combined information, and transmitting the combined information to another Client System for sharing;
searching lower layer information M_f.n combined information related to the T_f combined information being shared;
applying to information a client needs to transmit an encryption processing using the searched M_f.n combined information as a variable to create encrypted information, and transmitting the encrypted information to the client; and
applying to the information the client received a decryption processing using the searched M_f.n combined information as a variable to create decrypted information.
